(19) United States
(12) Patent Application Publication
(10) Pub. No.: US 2025/0190437 A1
(43) Pub. Date: Jun. 12, 2025

(54) PORTABLE QUERY LANGUAGE FOR USE WITH MULTIPLE INTERFACES

(71) Applicant: GitLab Inc., San Francisco, CA (US)

(72) Inventor: John Hope, Dublin (IE)

(21) Appl. No.: 18/535,317

(22) Filed: Dec. 11, 2023

(51) Int. Cl. G06F 16/2455; G06F 16/22; G06F 16/248; G06F 21/62

(52) U.S. Cl. CPC G06F 16/2455; G06F 16/2246; G06F 16/248; G06F 21/6218

(57) ABSTRACT

A system includes a computing server having a processor and memory. The memory is configured to store code including instructions. The instructions, when executed by the system, cause the system to perform steps including receiving a query from a user device, identifying a first interface of a plurality of interfaces on which to execute the query, converting the query into a first format suitable for use with the first interface, executing the query in the first format on a first target system that uses the first interface such that the query is transmitted to the first target system in the first format and the first target system processes the query by retrieving or modifying requested data, and receiving the results of the executed query from the first target system. A graphical user interface is in communication with the computing server and configured to display the received results.

### BACKGROUND

### Technical Field

The subject matter described relates to converting a single query into one or more formats suitable for use with different interfaces and executing each converted query in a corresponding format on a system that uses the corresponding format.

### Background Information

There are many challenges associated with the execution of queries across multiple platforms. For example, querying data from disparate systems often requires users to navigate different languages, formats, and protocols, making seamless execution a demanding and time-consuming process. Furthermore, maintaining security and access control poses significant challenges in multi-interface environments, as users require varying levels of permissions to access sensitive data. Ensuring that queries respect these permissions and do not compromise data confidentiality and integrity can be a complex and resource-intensive task. Specifically, implementing a query language may open a new vector for security and performance issues that is particularly difficult to maintain, as it may provide a level of freedom to the user that can provide new ways for users to interact with a system in unintended ways. These obstacles together may contribute to a steep learning curve and inefficiencies in handling query execution and data management across different platforms.

### SUMMARY

The above and other problems may be addressed by systems and methods for converting a query in a universal query language into one or more formats suitable for use with a plurality of interfaces and executing each converted query in a corresponding format on a system that uses the corresponding format. In one embodiment, the system includes a computing server having a processor and memory. The memory is configured to store code including instructions. The instructions, when executed by the system, cause the system to perform steps including: receiving a query from a user device: identifying a first interface of a plurality of interfaces on which to execute the query: converting the query into a first format suitable for use with the first interface; executing the query in the first format on a first target system that uses the first interface such that the query is transmitted to the first target system in the first format and the first target system processes the query by retrieving or modifying requested data; and receiving the results of the executed query from the first target system. A graphical user interface is in communication with the computing server. The graphical user interface is configured to display the received results.

### BRIEF DESCRIPTION OF THE DRAWINGS

Figure (FIG. 1 is a block diagram of a networked computing environment in which a universal query language may be used, according to one embodiment.

FIG. 2 illustrates a block diagram of the computing server of FIG. 1, according to one embodiment.

FIG. 3 illustrates an example of a tree structure for a query, according to one embodiment.

FIG. 4 illustrates a first flowchart depicting an example process for converting and executing a query, according to one embodiment.

FIG. 5 illustrates a second flowchart depicting an example process for converting and executing a query, according to one embodiment.

FIG. 6 is a block diagram illustrating an example computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements unless the context indicates otherwise.

### Example Systems

FIG. 1 illustrates one embodiment of a networked computing environment 100 in which a universal query language may be used. In the embodiment shown, the networked computing environment 100 includes one or more client devices 120, a computing server 130, a database 150, a version control system 160, a cloud-based storage system 170, an enterprise resource planning (ERP) system 180, web application programming interfaces (APIs) 190, all connected via a network 140. In other embodiments, the networked computing environment 100 includes different or additional elements. In addition, the functions may be distributed among the elements in a different manner than described.

A client device 120 is a computing device (e.g., desktop, laptop, tablet, smartphone, etc.) that a user can use to interact with the computing server 130. For example, the user can use the client device to send a query to the computing server. A query can be a request for information from a database or data storage system. The query can be used to retrieve, filter, manipulate, or modify data stored in a system based on certain conditions or defined criteria. The query can be formulated using a specific query language or syntax.

For example, a user can use a query to interact with Git, a version control system (VCS) used for managing source code. One example of a query in Git is the following. Git log such as “git log—oneline—graph”: this query requests the commit history of a repository, showing details such as commit author, date, and commit message. Users can specify various options to filter or format the output, such as showing only specific commits or displaying a graphical representation of the commit tree.

A user may interact with an application or a web interface (GUI) on the client device 120 to enter a query. The interface may include text input fields, drop-down menus, or graphical components for constructing the query. For example, as the user inputs the query, the client application may perform local validation checks to ensure the query is properly formatted and complies with the rules of the system. The validation can include checking for syntactic correctness and mandatory fields before allowing the query to be submitted. For example, once the query is correctly formulated, the user submits the query by clicking a button or pressing a key, such as “Enter” or “Submit” on the client application. In some embodiments, this triggers the client application to package the query as a request to be sent to the computing server. For example, the client application prepares the request, which includes the entered query along with any additional necessary information, such as user identification or authentication tokens. The request may be formatted as an HTTP or HTTPS request, an API call, or any other suitable communication method. The prepared request is transmitted from the client device 120 to the computing server 130 through the network 140. In other embodiments, the client device 120 may process and convert the query into an appropriate format for execution on the target system. In these cases, after converting the query into the appropriate format, the client device 120 may either directly send the converted query to the target system or transmit it to the computing server for delegation to the target system. Further information on these embodiments can be found throughout the present disclosure.

The network 140 provides the communication channels via which the other elements of the networked computing environment 100 communicate. The network 140 can include any combination of local area and wide area networks, using wired or wireless communication systems. In one embodiment, the network 140 uses standard communications technologies and protocols. For example, the network 140 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 140 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 140 may be represented using any suitable format, such as hypertext markup language (HTML) or extensible markup language (XML). In some embodiments, some or all of the communication links of the network 140 may be encrypted using any suitable technique or techniques.

The computing server 130 facilitates collaboration between different components of the system 100 and provides a centralized point of control. The computing server 130 manages the communication, query processing, and interaction with target systems 150, 160, 170, 180, 190 to fulfill the user's request effectively and securely.

The computing server 130 can listen for incoming requests from the client device 120 over the communication channels provided by the network 140. Upon receiving a request, the computing server can process the query contained within the request. For example, the computing server extracts essential information from the received request, including the query, user identification, authentication tokens, and any additional parameters or metadata. It may also validate the request further to ensure it meets the system's security and formatting requirements before proceeding. If the system requires user authentication, the server checks the user identification and authentication tokens against its user database or authentication service to verify the user's identity and ensure they have appropriate permissions to perform the requested query. The computing server can analyze the received query to determine the appropriate interfaces and/or target systems to use for query execution. This step may involve parsing the query into different components, such as tokens, relational operators, values, or logical operators.

Based on the identified target systems and their corresponding interfaces, the computing server can convert the query into suitable formats matching each target system's accepted query language or syntax. Converting the query into suitable formats for each target system offers significant advantages such as streamlined user experience, centralized query management, consistent data access, improved security, enhanced query optimization and simplified system maintenance. Further, by converting a query into suitable formats for each target system, the system becomes more scalable, as it can easily adapt to accommodate additional target systems or cater to larger data volumes. Centralizing query processing and execution simplifies scalability management, ultimately enhancing overall system performance and resilience. Overall, these features lead to a more efficient, secure, and user-friendly experience across multiple target systems. In embodiments where the client device 120 in FIG. 1 is tasked to convert the query into suitable formats for matching a target system's accepted query language, the client device 120 performs steps similar to those performed by the computer server 130 to convert the query. Once the query is converted into one or more suitable formats, the client device 130 may send the converted query to the target system, or it may send it the computing server for delegation to the target system.

The converted queries can then be executed on their respective target systems, which process the query and retrieve or modify requested data accordingly. The computing server handles any necessary communication with each target system to send a query and receive the results. When querying multiple systems, the computing server can aggregate the obtained results based on the system's rules and requirements, preparing a unified result set to be sent back to the user. The computing server packages the aggregated results into a response format compatible with the client device, such as HTTP, HTTPS, or API response, and sends it back to the client through the network. The advantages of aggregation include unified data presentation, facilitated access control, improved performance, enhanced scalability, conflict resolution, streamlined troubleshooting, and reduced network overhead. Aggregating results from multiple target systems offers a centralized method for combining data, ensuring accuracy and consistency while providing a user-friendly output and improved system performance. In some embodiments, the computer server may split up into various parts and execute it multiple times against the same target system. For example, the query syntax may allow the user to join results in a way the target system does not support. Therefore, the computing server or (client device) may issue multiple queries and combine the results.

Different types of target systems can be queried. For example, each target system can have a have unique interface and query language tailored to its specific implementations and data structures. Some examples of target systems are the database 150, the VCS 160, the cloud-based storage system 170, ERP system 180, and the Web APIs 190. In some embodiments, the computing server may also act as a target system with various interfaces like GraphQL, Advanced Search, REST, RSS, and so forth. For example, the server may handle authentication and authorization centrally, and hence, may offer functionalities similar to those of a target system, by interpreting and delegating to the data stores.

The database 150 can be a SQL database, a NoSQL database, a file-based storage system or a data warehouse. The SQL database is a relational database that uses a structured query language (SQL) for querying and managing data. The NoSQL databases are non-relational databases that utilize various data models and query formats specific to their implementations. File-based storage systems store and manage data in file formats, such as CSV, JSON, or XML files. Querying these systems may involve custom scripts or tools that parse and manipulate the data according to user queries. Data warehouses are large-scale data storage and processing systems designed for handling immense volumes of structured and unstructured data.

The VCS 160 manages and track changes to files over time, often in the context of software development. While VCSs primarily deal with code and file revisions rather than database-like queries, they provide custom interface commands and mechanisms to access and retrieve information about a project history, file versions, and other metadata.

The cloud-based storage systems 170 are platforms that store and retrieve data in the cloud, accessible through custom interface commands or APIs.

The ERP systems 180 are platforms that manage various business aspects, such as accounting, human resources, customer relationship management, and supply chain management. These systems can offer specific interfaces for data querying and manipulation.

The Web APIs 190 are systems that provide access to their data or services through specified query formats and protocols, for example over HTTP or HTTPS.

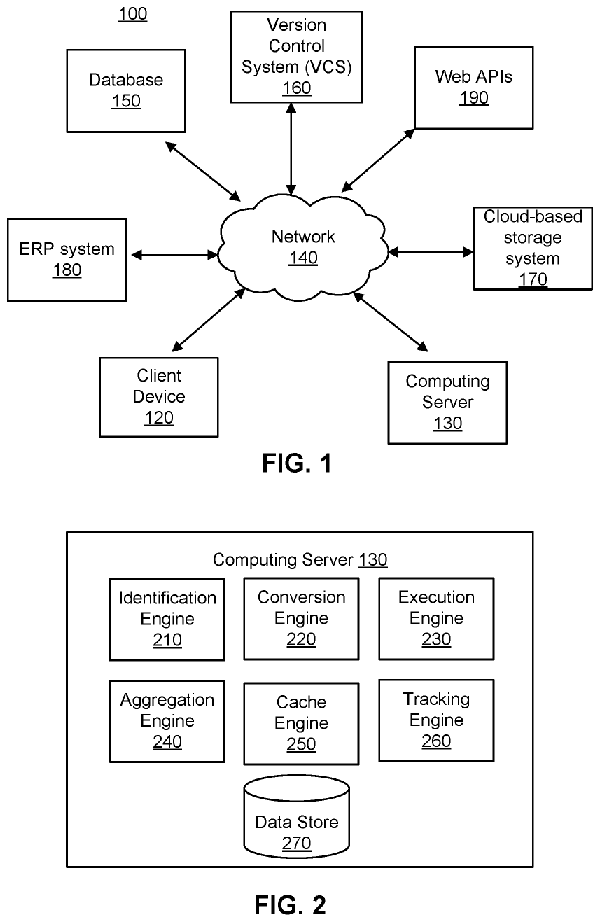

FIG. 2 illustrates one embodiment of the computing server 130 of FIG. 1. In the embodiment shown, the computing server 130 includes an identification engine 210, a conversion engine 220, an execution engine 230, an aggregation engine 240, a cache engine 250, a tracking engine 260, and a data store 270. In other embodiments, the computing server 130 includes different or additional elements. In addition, the function of the computing server may be distributed among the elements in a different manner than described.

In some embodiments, the identification engine 210, the conversion engine 220, the execution engine 230, the aggregation engine 240, the cache engine 250, and the tracking engine 260 may include one or more processors that execute machine instructions stored in the data store 270 to enable execution of different processes and/or transaction types as mentioned in the present disclosure, and to manage the data stored in the data store 270.

The identification engine 210 provides the tools to analyze a query received by the computing server and determine different parameters associated with the received query. For example, the identification engine can identify a first interface of a plurality of interfaces on which to execute the query.

In one embodiment, the identification engine determines the appropriate interface(s) and target system(s) to use for query execution. Upon receiving a query, the identification engine extracts information from it, such as the query itself, user identification, authentication tokens, and any additional parameters or metadata. Based on this information, the engine then identifies the target systems that are suitable for processing the query. The identification process may involve analyzing the query's structure, keywords, or data source requirements to select the appropriate target systems that can satisfy the query. By choosing the right target systems and their corresponding interfaces, the identification engine ensures that the query is directed to the most relevant data sources and that it can be executed effectively and efficiently.

In one embodiment, if a user explicitly identifies the interface or target system in the query itself, the identification engine can determine this information by parsing and analyzing the query for specific keywords, elements, or structures that correspond to the mentioned interface or target system. To achieve this, the identification engine can be programmed with a set of rules and patterns that represent various interfaces and target systems. These rules and patterns may be based on known keywords, syntax, or metadata embedded in the query that signifies the selected interface or target system. In some embodiments, the identification engine may infer user intention based on which part of the user interface the user is interacting with.

For example, if the user wants to filter issues in an issue list, the identification engine may recognize this intention and generate a URL for the user to access the filtered list. For example, if the user wants to embed a list of merge requests (MRs) in a piece of content, the identification engine may understand this intention and use GraphQL to efficiently retrieve the required data. During the parsing and analysis of the query, the identification engine looks for these distinguishing elements and matches them against the predefined rules and patterns. If a match is found, the identification engine recognizes the user-specified interface and target system and directs the rest of the query processing pipeline accordingly. The engine can then bypass or modify the target system identification process based on this user-provided information. In cases where the user has provided incomplete or ambiguous information about the interface or target system, the identification engine may attempt to resolve the ambiguity using additional rules, heuristics, or fallback strategies to make a choice for query execution.

In one embodiment, when a user does not provide the interface or target system in the query, the identification engine may take on the responsibility of determining the appropriate interface(s) and/or target system(s) for query execution. In such cases, the identification engine analyzes the query to understand its structure, keywords, or data source requirements. Based on this analysis, the engine selects the target systems that can fulfill the query's purpose. It may use predefined rules, heuristics, or algorithms that are designed to select the best-suited target systems based on available information. For example, the identification engine may determine factors such as data relevance, query performance, target system availability, and resource usage while selecting the target systems. It may also choose to dispatch the query to multiple target systems if the query requires data from different sources or needs to be aggregated from various systems.

After the identification process, the identification engine provides this above-mentioned information to other components within the computing server which then proceed with the subsequent steps of query conversion and execution on the identified target systems.

The conversion engine 220 converts the query into a format suitable for use with the identified interface(s). One of the purposes of the conversion engine 220 is to ensure that user queries are translated into the appropriate formats required for execution on the identified interface(s) and target system(s). Advantages of converting a query into suitable formats for each target system can include streamlined user experience, centralized management, consistent data access, improved security, enhanced optimization, simplified maintenance, reduced network overhead, and increased scalability. These benefits can lead to a more efficient, secure, and user-friendly system.

The conversion engine may analyze the query's components, including tokens, relational operators, values, and logical operators. Then, the conversion engine may determine the required query language or syntax needed for each interface or target system. Different systems may use unique query languages or syntax, such as SQL for relational databases or specific API calls for cloud-based storage systems. After that, the conversion engine may transform the query into a format compatible with each identified interface or target system. This process may involve converting the query structure, elements, and operators to match the language or syntax of the interface. The, the conversion engine may perform transformations, replacements, or mappings on the query. For example, the conversion engine undertakes various transformations, replacements, or mappings based on predefined rules or algorithms to ensure the query is in the correct format for each interface or system.

In certain embodiments, the conversion engine can be implemented as a compiler or a transpiler, depending on the specific requirements and use cases. For example, the conversion engine may be implemented as a transpiler if the source and target languages are similar and at the same abstraction level. For instance, when converting a query from a first language, such as GitLab Query Language (GLQL), into different public interfaces such as GraphQL, Lucene Syntax, or simply a URL with parameters, a transpiler may be well-suited for this purpose.

To provide a specific example, in one embodiment, the following query is received at the computing server:

assignee = currentUser( ) AND label in (“devops::plan”, “devops::create”)
AND confidential = true.

The conversion engine can translate this query into a suitable format for each target interface. At the identification stage, the identification engine identifies the target interfaces it needs to translate the query for, such as GraphQL, SQL, or specific API calls for different systems. At the conversion stage, the conversion engine first parses the query, breaking it down into components such as tokens (assignee, label, confidential), relational operators (=, in), logical operators (AND), values (“devops::plan”, “devops::create”, true), and function calls (currentUser( )).

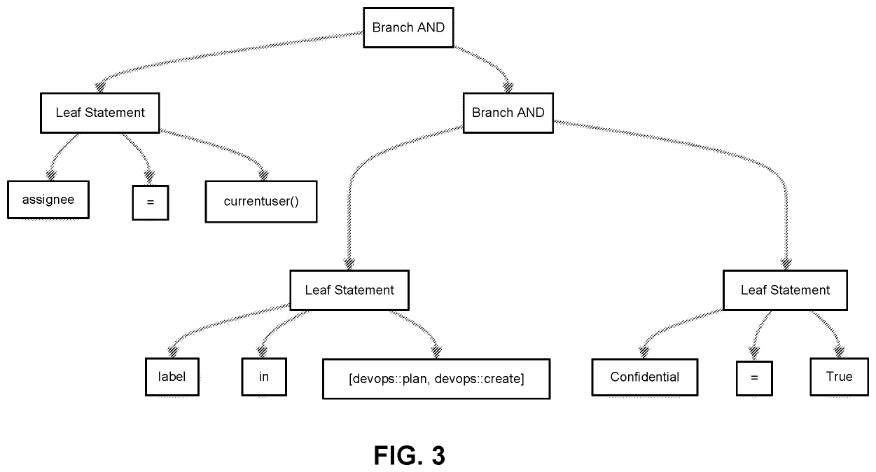

The conversion engine then creates an Abstract Syntax Tree (AST), which is a hierarchical representation of the parsed query. This tree contains the query structure, capturing the relationships between components and operators. An example of a tree structure for the given query in provided in FIG. 3.

For each identified interface or target system, the conversion engine translates the query into the required format, leveraging the AST to maintain the relationships and meanings of the different query components. This process involves adapting operators, functions, and values to match the syntax or language of the target interface. The conversion engine may also handle pagination, filtering, or other features specific to the target system. For example, if the target interface is GraphQL, the converted query might look like:

```
query {
  nodes {
    issues (assigneeUsername: “currentUser”, labels:
[“devops::plan”, “devops::create”], confidential: true) {
        id
        title
        labels
        }
    }
      }
```

The conversion engine exports the translated query in the format compatible with the targeted interface(s) or system(s), enabling execution on those platforms. In some cases, additional steps for optimization or verification might be performed before output if needed.

Once the query is converted in the format compatible with the targeted interface, the execution engine 230 executes the query on the target system that uses the targeted interface. As such, the query is transmitted by the execution engine to the target system in the correct format and the target system processes the query by retrieving or modifying requested data. In particular, the execution engine may handle the communication, query execution, and result retrieval processes during the query execution step, dealing with the particularities of each target system or interface.

For example, the execution engine prepares to connect and interact with the identified target systems or interfaces. This might involve setting up authentication, establishing connections, or initializing the necessary resources.

In one embodiment, the execution engine 230 runs the translated query on the respective target interface or system and retrieves the results. The specific actions performed during this step may vary depending on the target system's requirements and interface type.

For example, for queries translated into RESTful API requests, the execution engine sends HTTP requests to the target system's API endpoints. These requests may use methods like GET, POST, PUT, or DELETE, and include the necessary query parameters, headers, and authentication information. The execution engine then waits for the API response, which may include JSON, XML, or other data formats.

For example, for queries converted into GraphQL format, the execution engine sends a single request to the target system's GraphQL endpoint, including the query string and any required variables, headers, or authentication data. The server processes the request and returns a response containing the requested data, errors, or both, typically in JSON format.

For example, for queries translated into SQL, the execution engine connects to the target relational database, such as MySQL, using appropriate database connectors or drivers. The engine then executes the SQL query and retrieves the results as rows or tabular data, handling any errors or exceptions that might occur during this step.

For non-standard interfaces or custom systems, the execution engine may follow the specific protocols, APIs, or query languages required to interact with those systems. This may involve using third-party libraries, SDKs, or proprietary connectors to establish communication and query execution.

Once the results are retrieved, the execution engine proceeds to process and format the results, continuing with the subsequent steps of its workflow. In some cases, the execution engine may perform some post-processing steps, such as applying additional filters, pagination, sorting, or aggregation of the results to meet final output requirements.

After the results are received, the execution engine forms the final output based on the processed results from the target systems or interfaces. This output can be forwarded to a graphical user interface of a client device or other components in the system for presentation or further processing. The graphical user interface may be in communication with the computing server such that the graphical user interface can display the received results.

Once the results are received and processed, the execution engine may close any open connections to the target systems or interfaces and releases any resources used during the process.

The aggregation engine 240 combines the results from multiple target systems and prepares the aggregated data for display in the graphical user interface of a client device. The aggregation engine focuses on ensuring data consistency, handling conflicts or discrepancies, and delivering accurate, well-organized results to be displayed on the graphical user interface. In one embodiment, the aggregation engine may use a set of predefined rules to guide data combining and processing. These rules may define how to merge data with similar attributes, resolve potential conflicts or discrepancies, and prioritize results in a specific order. As new scenarios or requirements arise, the rules can also be updated, allowing the engine to evolve and adapt to various data types and target systems. The advantages of aggregation include unified data presentation, facilitated access control, improved performance, enhanced scalability, conflict resolution, streamlined troubleshooting, and reduced network overhead. Aggregating results from multiple target systems offers a centralized method for combining data, which can improve accuracy and consistency while providing a user-friendly output and better system performance.

In one embodiment, the aggregation engine may use one or more algorithms to perform intelligent aggregation of query results. The algorithms can be tailored to specific types of data or based on statistical techniques to analyze the data and determine the optimal way to merge the results. The aggregation engine may also use machine learning or artificial intelligence techniques to improve the aggregation process over time, learning from previous successful or unsuccessful operations.

In one embodiment, the aggregation engine operates as a modular framework where user can create plugins tailored to specific target systems or data types. Each plugin can define its own processing logic, enabling customization for various scenarios. This approach allows the aggregation engine to be extended as required, providing flexibility to accommodate new target systems or implement advanced aggregation techniques without changing the core system.

The cache engine 250 manages caching of previously executed queries and their results to improve the system's performance by reducing the need for repetitive processing of frequent queries. In one embodiment, the cache engine stores the query results in the data store 270 of the computing server. This approach allows for the rapid retrieval of cached results, reducing response times for frequently executed queries.

In one embodiment, the cache engine utilizes a network of cache servers or nodes to store and manage the cached queries and results. This approach provides increased scalability and can better handle large amounts of data, as the cache storage capacity can be expanded by adding more cache servers or nodes to the network. Distributed caching ensures optimal performance and load balancing across multiple cache storage locations.

The tracking engine 260 enables users to track, compare, and/or revert their queries or any changes made over time. In one embodiment, the tracking engine manages query histories and changelogs stored in the data store 270. Users can access the tracking engine to review, compare, and revert their queries as needed. This centralized architecture provides for maintenance of all query versions and associated metadata at a single location, which can enable easy and convenient review or auditing.

The data store 270 includes one or more computer-readable media that store data associated with the system, such as query execution results, user profiles, and other pertinent information. Query execution by the computing server may produce results from multiple target systems. The data store 270 may be responsible for retaining these results, facilitating further processing by other components, such as the aggregation engine 240. The data store 270 may save user profiles, preferences, access levels, and other relevant information that enables personalized and secure experiences for each user. By maintaining user information, the system can determine the appropriate scope of access for executing queries, respecting security and permission boundaries.

When the cache engine 250 manages caching of previously executed queries and their results, the data store 270 can serve as a storage location for this cached data. This ensures quick access and retrieval of previously executed queries, reducing redundant processing and enhancing system performance.

The data store 270 can integrate with the tracking engine 260 to store query histories, changelogs, and metadata. This centralized storage for tracking and control-related data allows users to locate, compare, and revert specific changes easily, helping maintain efficient version control throughout the system.

### Example Methods

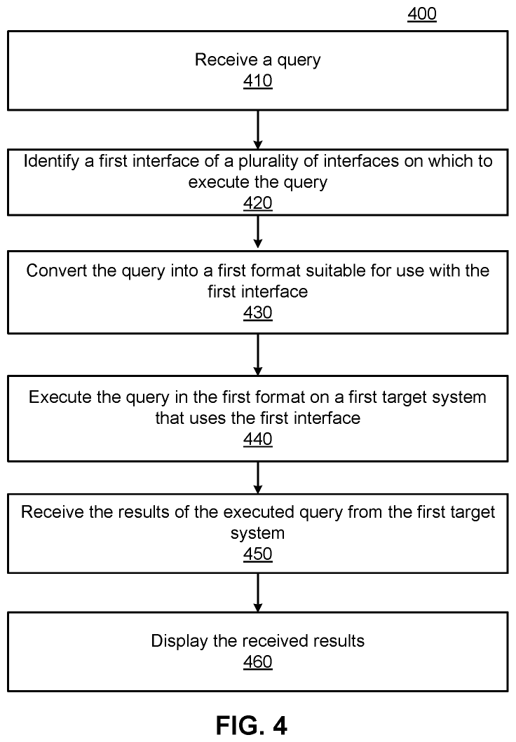

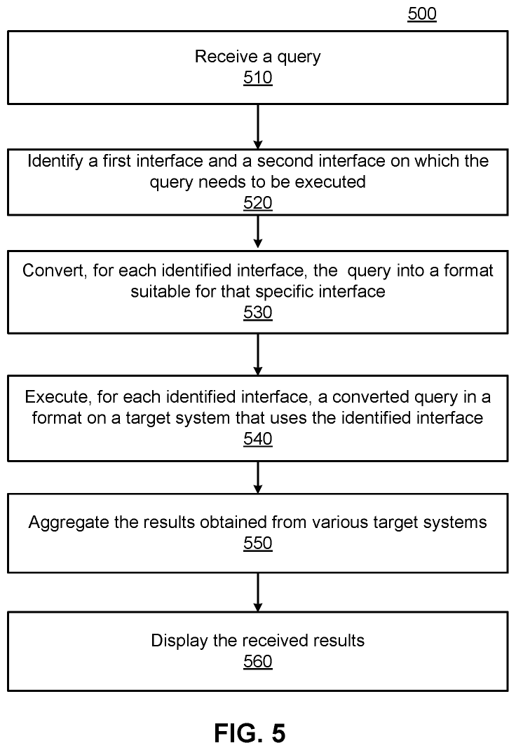

FIG. 4 is a flowchart depicting an example process 400 for converting and executing a query, in accordance with some embodiments. Various steps in the process 400 may be processes that are performed by the identification engine 210, the conversion engine 220, the execution engine 230, the aggregation engine 240, the cache engine 250, the tracking engine 260, or other engines of the computing server 130. Various processes may be implemented as one or more software algorithms. The software algorithm may be stored as computer instructions that are executable by one or more general processors (e.g., CPUs, GPUs). The instructions, when executed by the processors, cause the processors to perform various steps described. In various embodiments, one or more steps described may be skipped or changed. Steps described in FIGS. 4 and 5 may also be combined with those in other figures. A computer-implemented method (or process) may be performed by the computing server 130, although the process may also be performed by another suitable computer.

At 410, the computing server receives a query. In one embodiment, a user submits a query through a user device (e.g., a web application, desktop application, or mobile app) connected to the computing server. The user device sends the query to the computing server. This transmission often takes place using a communication protocol, such as HTTP, WebSocket, or other suitable protocols that facilitate data exchange between the user device and the server. Upon receiving the query, the computing server may first check the user's authentication and verify her access rights. This step could involve confirming the user's credentials, such as through an authentication token or a username and password. The server then proceeds to validate the query, ensuring it adheres to the proper syntax and structure for processing. This step may involve checking for any malformed, incomplete, or ambiguous elements within the query. After authentication and validation, the computing server forwards the query to the appropriate engine or component for further processing.

At 420, the computing server identifies a first interface of a plurality of interfaces on which to execute the query. For example, the step of identifying the first interface involves determining the most appropriate interface and target system for executing the query within the plurality of available options. The identification engine within the computing server can carry out this process.

In one embodiment, upon receiving the query, the identification engine analyzes its structure, keywords, and data source requirements. This analysis helps it identify the specific type of data that the query seeks and the systems that may fulfill that request. The identification engine then looks for an interface or target system matches based on the analyzed query. It considers predefined rules, patterns, or heuristics related to various interfaces and target systems. Examples of target systems include relational databases, NoSQL databases, APIs, Caches, cloud-based storage systems and the computing server itself. In some cases, the user may have explicitly mentioned the interface or target system, for example, within the query itself. The identification engine may detect such information by parsing and analyzing the query for specific keywords, elements, or syntaxes associated with known interfaces or systems. If the user-specified information is incomplete or ambiguous, the engine may employ additional rules or fallback strategies for selecting the best possible interface.

After analyzing the query and matching it with a potential interface, the identification engine selects the interface for executing the query based on various factors. These factors could include data relevance, query performance, target system availability, and resource usage. In instances where the query necessitates data from different sources or aggregation from various systems, the engine chooses multiple interfaces and target systems accordingly. These instances will be discussed further in the present disclosure. Once the first interface has been identified, the computing server proceeds with further steps like query conversion, execution, and aggregation.

At 430, the computing server converts the query into a first format suitable for use with the first interface. In one embodiment, the conversion engine within the computing server is responsible for carrying out this process. After receiving the query, the conversion engine first breaks it down into components, such as tokens (e.g., keywords or variables), relational operators (e.g., =, <, or >), logical operators (e.g., AND, OR, or NOT), values (e.g., numbers, strings, or dates), and function calls (e.g., COUNT( ) or AVG( )). The conversion engine then constructs an Abstract Syntax Tree (AST), which is a tree-like hierarchical representation of the parsed query. This tree captures the relationships and structure of the query components, making it easier for the engine to manipulate and convert the query. Next, the conversion engine determines the required query language or syntax for the first interface identified by the identification engine. Different target systems may use distinct query languages or syntax, such as SQL for relational databases, GraphQL for graph databases, or specific API calls for cloud-based storage systems.

With the required format determined, the conversion engine now proceeds to transform the query into the first format compatible with the first interface. This process involves converting the query structure, elements, and operators to match the language or syntax of the target system. The engine utilizes the AST to maintain the relationships and meanings of the different query components while performing the transformation. In some cases, the conversion engine might carry out additional optimization or verification steps to further refine the converted query or ensure it adheres to the syntax and structure requirements of the first interface. Once the query is converted into the first format suitable for use with the first interface, the computing server can proceed with the execution step.

At 440, the computing server executes the query in the first format on a first target system that uses the first interface such that the query is transmitted to the first target system in the first format and the first target system processes the query by retrieving or modifying requested data. For example, the execution engine within the computing server is responsible for carrying out this process. In one embodiment, the execution engine starts by setting up everything required to connect and interact with the first target system and its associated first interface. This step might involve preparing authentication, establishing connections, initializing resources, or setting up necessary drivers and connectors. Following the connection setup, the execution engine sends the converted query in the first format to the first target system through the first interface. The specific method employed depends on the target system's requirements and interface type. For API-based systems (e.g., RESTful APIs), the engine sends HTTP requests with the necessary query parameters, headers, and authentication information to the system's API endpoints. For GraphQL-based systems, the engine sends a single request to the GraphQL endpoint with the query string, required variables, headers, and authentication data. For SQL databases, the engine connects to the target relational database using appropriate database connectors or drivers and executes the SQL query.

At 450, the computing server receives the results of the executed query from the first target system. For example, the process of receiving the results can depend on the type of interface or target system involved, as well as the query format used. Upon transmitting the query to the first target system, the execution engine monitors the response from the target system to check when the processing is completed and when the results are available. Once the target system has completed processing the query, it sends the results back to the execution engine. The response might be in a specific format, such as JSON, XML, or tabular data, depending on the type of target system, interface, or query language used. When the execution engine receives the results, it starts parsing the received data. Parsing may involve decoding the received format and extracting relevant information, such as records, rows, fields, or data points, depending on the specific requirements and use cases. During the result-receiving process, the execution engine may encounter errors or exceptions. These could be caused by issues like timeouts, connection failures, incorrect data formats, or processing errors in the target system. In such instances, the execution engine has mechanisms to handle these errors and, if possible, tries to recover or retries the process, or notifies the user about the error. In some embodiments, if the execution engine fails to detect any malformed query, the query proceeds to the target system, which generates an error that can be reported back to the user.

After parsing the results, the execution engine may perform some post-processing steps on the received data. This can include additional filters, pagination, sorting, or aggregation. This step reshapes the received data according to the final output requirements. Once the results have been received and processed, the execution engine forwards these results to other components in the system, such as the graphical user interface, for presentation or further processing.

At 460, the received results are displayed. In particular, after the computing server receives the query results from the target system, it can display the results on a graphical user interface (GUI) of the user's device. The GUI is in communication with the computing server. The GUI is configured to display the received results.

In particular, the process of displaying the received results involves several steps. For example, once the query results have been received and processed by the execution engine and other components, the computing server forwards these results to the GUI running on the user device. This may involve sending the results via a communication channel, such as a WebSocket, REST API, or other similar mechanisms. Upon receiving the results, the GUI can prepare the data for display. For example, it formats the results in a user-friendly manner, converting raw data into a more readable and comprehensible format. This may involve transforming data types, applying formatting rules for dates, numbers, or text, and sorting or grouping data based on the user's needs. The GUI can create visual elements to display the results effectively. This can include tables, charts, graphs, lists, or other visual representations that best suit the data types and requirements of the specific use case. The GUI may use libraries or frameworks to generate these visuals efficiently.

With the visual elements ready, the GUI can integrate them into the existing interface layout. For example, it updates the interface by adding, replacing, or modifying elements to display the received results. This may include updating existing visuals or adding new elements to the interface. Once the results are displayed on the GUI, users can interact with the displayed data. The GUI allows users to navigate, explore, filter, or manipulate the results, providing them with control over the presented data. The GUI may also enable users to perform additional actions, like exporting the results or adjusting the displayed data to suit their requirements. As users interact with the displayed results, they may also submit new queries or request additional data. The GUI may send these new queries or requests to the computing server, creating a feedback loop in which the computed server processes further queries, and the GUI updates to display the new results. The process of displaying the received results on a graphical user interface ensures that users can effectively interpret and interact with the data retrieved by the query execution.

In some embodiments, the computing server stores a previously executed query or its results to reduce a processing load on a target system and improve response times for frequently executed queries. The computing server can identify frequently executed queries by monitoring query patterns, user behavior, or leveraging analytical algorithms to predict which queries may be frequently executed. When a query is executed and its result is obtained, the computing server saves the query and its result in the cache. The cache can be implemented using the data store component of the computing server or by utilizing a network of cache servers or nodes to distribute the caching process.

When a user submits a query, the computing server can check if the query or its result is already present in the cache. If the query/result is found in the cache, the computing server retrieves it directly from the cache instead of re-executing the query on the target system. By storing and retrieving previously executed queries or their results from the cache, the system can effectively reduce the processing load on target systems and improve response times for frequently executed queries. In some embodiments, the system periodically updates the cache to ensure that it contains relevant and up-to-date information. This may involve removing old or infrequently accessed entries, as well as keeping track of updates or modifications in the target system that might impact the cached data. Cache management algorithms can also be implemented to optimize cache usage, such as Least Recently Used (LRU) or Time-To-Live (TTL) policies.

In some embodiments, the computing server allows users to track, compare or revert changes to their queries over time. By managing query histories and changelogs, the computing server can provide users with useful features to review, compare, and revert the queries as needed, enhancing their ability to manage and refine their queries for better results. In some embodiments, the computing server records and stores each submitted query, along with its associated metadata such as timestamp, user identification, and any other relevant information. This query history can be stored in the data store component, comprising both the query and the results obtained from its execution.

The computing server can maintain a changelog that tracks all modifications or revisions made to the queries over time. This enables users to examine how the queries evolved and understand the reasoning behind each change. Users can access the query history and changelogs to compare different versions of their queries. By displaying the differences between query versions side-by-side, users can easily analyze the changes and identify the impact of each modification on the results. The computing server allows users to revert their queries to a previous version if desired. By selecting an earlier version from the query history, the user can effectively roll back to that version, undoing any unwanted changes and restoring the query's prior state.

In some embodiments, the computing server can maintain a version control feature, allowing users to access query tracking, comparison, and reversion functionalities. This simplifies the workflow, enabling users to easily navigate between query versions, compare changes, and revert as needed. By offering users the ability to track, compare, and revert their queries over time, the computing server enhances the overall query management process and gives users more control over their data exploration tasks.

In some embodiments, the computing server determines a level of access granted to the user and executes the query based on the level of access granted to the user to ensure that the query respects security and permission boundaries granted to the user. To determine the level of access granted to the user, the computing server authenticates the user by verifying their credentials, such as username and password, or through more advanced methods like multi-factor authentication or single sign-on (SSO). After authentication, the computing server retrieves the user's profile from the data store, which contains user identification, roles, groups, and associated permissions and access levels. Then, the user's profile is analyzed to identify their permission settings and access levels within the system. These permissions may be derived from predefined roles or groups, or assigned individually to specific users.

To execute the query based on the level of access granted to the user, upon receiving a query from an authenticated user, the computing server verifies that the user has the necessary permissions to execute the query. If the user does not have the required access, the computing server may either reject the query or modify it to align with the user's permissions. During target system selection (performed by the identification engine), the computing server takes into account the user's access level. It ensures that the query is only sent to authorized target systems or data sources that the user has permission to access. The computing server can adjust the query as needed to comply with the user's access level. This may involve filtering requested data or adjusting the query structure to match the user's permissions.

The computing server can process the query on target systems while adhering to the user's access level. This may involve limiting data retrieval, enforcing query restrictions, or applying additional permission-related constraints. Once the query is executed, the results can be transmitted by the computing server to the client device for display on the graphical user interface. The system may apply further access level restrictions or filtering to the results, ensuring that the user only views information they are allowed to see.

In some embodiments, the computing server can parse the query by splitting the query into tokens, relational operators, values, or logical operators and organize the parsed query into a logical tree. The query can be converted into a first format and/or a second format using the logical tree. The query can also be converted into multiple different formats using the logical tree.

FIG. 5 is a flowchart depicting an example process 500 for converting and executing a query, in accordance with some embodiments. Some of the steps in the process 500 may be similar to those of the process described in FIG. 4.

At 510, the computing server receives a query. The step of receiving a query is similar to step 410 of FIG. 4 as described in the present disclosure.

At 520, the computing server identifies both a first interface and a second interface for executing the query. This step follows a similar process as the one in step 420 of FIG. 4, as discussed in the present disclosure. In this scenario, identifying the first and second interfaces may be necessary when the query requires data from multiple sources or needs aggregation from various systems. By analyzing the query's structure, keywords, and data source requirements, the identification engine can determine the information needed from multiple interfaces or target systems. To identify the first and second interfaces, the identification engine looks for possible matches based on the analyzed query and predefined rules, patterns, or heuristics associated with various interfaces and target systems. The engine may consider factors such as data relevance, query performance, target system availability, and resource usage while selecting the appropriate interfaces. If the user-specified information in the query is insufficient or unclear, the identification engine resorts to additional rules or fallback strategies to choose the best possible interfaces. In cases where the query demands data from different sources or aggregation from multiple systems, the engine discerns the necessity for multiple interfaces and target systems.

At 530, the computing server converts, for each identified interface, the query into a format suitable for that specific interface. This step is similar to step 430 of FIG. 4 as described in the present disclosure.

Utilizing a single query converted into multiple formats for use with multiple target systems may offer several security and scalability advantages over querying each target system separately. This approach can simplify query management, enhance security and access control, optimize query execution, and improve overall system performance and scalability.

One advantage is the ability to provide simplified query management. In one embodiment, users only need to submit one query, which reduces the complexity of managing multiple queries for each target system. This simplifies the user experience, making it more efficient and less prone to errors. A user can save a query used on one target system and later copy and paste it for use on a different target system. Another advantage is the ability to provide centralized security. For example, with a single-query approach, the system can handle security measures such as authentication, authorization, and permission management in a centralized manner. This can allow for better control over access to data resources and reduce the risk of security breaches.

Another advantage is the ability to provide consistent data access control. For instance, by using a single query, it is easier to enforce consistent data access controls across all target systems. This enforces users only accessing the data they are authorized to view, regardless of which target system the data resides in. The described approach can also improve query optimization. For example, using a single query that is converted into multiple formats allows for query optimization and performance improvements. The system can choose the most efficient way to execute the query across the target systems, reducing the overall processing time and server load. The described approach can also provide for easier system maintenance. Centralizing the query processing and execution makes it easier to maintain and update the system, as changes only need to be made in one place. This simplifies the addition of new target systems or modifications of existing ones.

The described approach can also provide improved scalability and reduced network overhead. By handling the query conversion and execution centrally, the system can easily scale to accommodate more target systems or larger data volumes. Reducing the number of individual queries to target systems can help lower network overheads by reducing the amount of data to be transferred between the user device, the computing server and the target systems.

At 540, the computing server executes, for each identified interface, a converted query in a format on a target system that uses the identified interface. The step of executing a converted query in a format on a target system that uses a corresponding interface is similar to step 440 of FIG. 4 as described in the present disclosure.

At 550, the computing server aggregates the results obtained from a first target system and at least a second target system for display on the GUI of a device. For example, once the computing server runs a translated query on a corresponding target system, it retrieves the results therefrom, which may be in various formats depending on the target system's specifications (e.g., JSON, XML, rows, or tabular data). After retrieving results from the target systems, the computing server may perform some basic processing, such as applying filters, pagination, sorting, or other features specific to each target system. The processed results from each target system are then passed on to the aggregation engine.

The aggregation engine combines the results from multiple target systems, such as the first target system and the second target system. It may use predefined rules to guide data merging and processing, resolve potential conflicts or discrepancies, and prioritize results in a specific order. Some embodiments may use machine learning or artificial intelligence techniques to optimize the aggregation process over time. During the aggregation process, conflicts and discrepancies in the data might occur. The aggregation engine may use algorithms tailored to specific data types to analyze the data and determine how to merge the results. After aggregating the results, the aggregation engine prepares the final output based on the aggregated data from all target systems.

The aggregation process described in the application may offer several advantages including unified data presentation, facilitated access control, improved performance, enhanced scalability, conflict resolution, streamlined troubleshooting, and reduced network overhead. For example, aggregation can allow for the combination of data retrieved from multiple target systems into a single, unified output. This simplifies the presentation of results for the end-user and makes it easier to analyze and interpret the data. The aggregation engine can help enforce consistent access controls for users across all target systems. By handling the combination of data, it may ensure that proper permissions are in place and that users only receive the results they are authorized to access, regardless of the target system(s) involved. By aggregating data from various sources and systems, the system may deliver more relevant results to users in a more efficient manner. This can reduce the processing load on the target systems, leading to better response times and overall system performance.

In addition, aggregating data results may allow the system to scale more effectively as data volumes and the number of target systems grow. The aggregation engine can employ modular and distributed features to accommodate larger data sets and increased demand. The aggregation process can handle potential conflicts or discrepancies in data retrieved from multiple target systems. The aggregation engine may use predefined rules, algorithms, or even machine learning techniques to determine the appropriate way to combine and present results, ensuring accuracy and consistency in the output. In the case of data discrepancies or errors, the aggregation engine can pinpoint issues within the aggregated data. By centralizing the handling of data from multiple sources, the engine may more easily identify and resolve issues, which may in turn enhance the system's overall reliability and stability.

Aggregating results at the server level can reduce the amount of data transferred between the user devices and the target systems. This leads to lower network overheads and results in faster response times for the various queries executed.

At 560, the results are displayed. This step is similar to step 460 of FIG. 4 as described in the present disclosure.

### Computing System Architecture

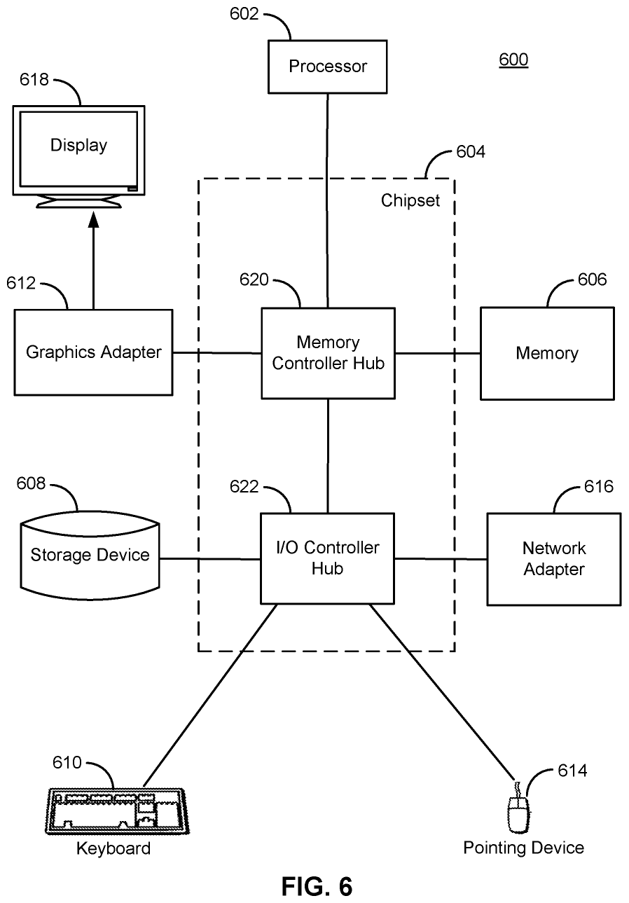

FIG. 6 is a block diagram of an example computer 600 suitable for use as a client device 120 or computing server 130. The example computer 600 includes at least one processor 602 coupled to a chipset 604. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

In the embodiment shown in FIG. 6, the storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, touch-screen, or other type of pointing device, and may be used in combination with the keyboard 610 (which may be an on-screen keyboard) to input data into the computer system 600. The graphics adapter 612 displays images and other information on the display 618. The network adapter 616 couples the computer system 600 to one or more computer networks, such as network 140.

The types of computers used by the entities of FIGS. 1 and 2 can vary depending upon the embodiment and the processing power required by the entity. For example, the computing server 130 might include multiple blade servers working together to provide the functionality described while the client device 120 might be a desktop workstation or tablet. Furthermore, computers 600 can lack some of the components described above, such as keyboards 610, graphics adapters 612, and displays 618.

### Additional Considerations

Some portions of the above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process/method as described in the present disclosure. Thus, while particular embodiments and applications have been illustrated and described, it is to be understood that the described subject matter is not limited to the precise construction and components disclosed. The scope of protection should be limited only by any claims that issue.

What is claimed is:

1. A system, comprising:
a computing server comprising a processor and memory in communication with the processor, the memory configured to store code comprising instructions, wherein the instructions, when executed by the system, cause the system to perform steps comprising:
receiving a query from a user device;
identifying a first interface of a plurality of interfaces on which to execute the query;
converting the query into a first format suitable for use with the first interface;
executing the query in the first format on a first target system that uses the first interface such that the query is transmitted to the first target system in the first format and the first target system processes the query by retrieving or modifying requested data; and
receiving the results of the executed query from the first target system; and
a graphical user interface in communication with the computing server, the graphical user interface configured to display the received results.

2. The system of claim 1, wherein the steps further comprise:
identifying a second interface on which to execute the query;
converting the query into at least a second format suitable for use with the at least second interface;
executing the query in the second format on the at least second target system that uses the at least second interface such that the query is transmitted to the at least second target system in the second format and the at least second target system processes the query by retrieving or modifying requested data;
receiving the results of the executed query from the at least second target system; and
aggregating the results from the first target system and the at least second target system for display on the graphical user interface.

3. The system of claim 1, wherein the steps further comprise:
storing a previously executed query or its results to reduce a processing load on target systems and improve response times for frequently executed queries.

4. The system of claim 1, wherein the steps further comprise:
allowing users to track, compare or revert changes to their queries over time.

5. The system of claim 1, wherein the steps further comprise:
determining a level of access granted to the user; and
executing the query based on the level of access granted to the user to ensure that the query respects security and permission boundaries granted to the user.

6. The system of claim 1, wherein the steps further comprise:
parsing the query by splitting the query into tokens, relational operators, values, or logical operators; and
organizing the parsed query into a logical tree,
wherein the query is converted into the first format using the logical tree.

7. The system of claim 6, wherein the steps further comprise:
identifying a second interface on which to execute the query;
using the logical tree structure to convert the query into a second format suitable for use with the second interface;
executing the query in the second format on the second target system that uses the second interface such that the query is transmitted to the second target system in the second format and the second target system processes the query by retrieving or modifying requested data;
receiving the results of the executed query from the second target system; and
aggregating the results from the first target system and the second target system for display on the graphical user interface.

8. A method, comprising:
receiving a query from a user device;
identifying a first interface of a plurality of interfaces on which to execute the query;
converting the query into a first format suitable for use with the first interface;
executing the query in the first format on a first target system that uses the first interface such that the query is transmitted to the first target system in the first format and the first target system processes the query by retrieving or modifying requested data;
receiving the results of the executed query from the first target system; and
causing a graphical user interface of an application running on the user device to display the received results.

9. The method of claim 8, further comprising:
identifying a second interface on which to execute the query;
converting the query into at least a second format suitable for use with the at least second interface;
executing the query in the second format on the at least second target system that uses the at least second interface such that the query is transmitted to the at least second target system in the second format and the at least second target system processes the query by retrieving or modifying requested data;
receiving the results of the executed query from the at least second target system; and
aggregating the results from the first target system and the at least second target system for display on the graphical user interface.

10. The method of claim 8, further comprising:
storing a previously executed query or its results to reduce a processing load on target systems and improve response times for frequently executed queries.

11. The method of claim 8, further comprising:
allowing users to track, compare or revert changes to their queries over time.

12. The method of claim 8, further comprising:
determining a level of access granted to the user; and
executing the query based on the level of access granted to the user to ensure that the query respects security and permission boundaries granted to the user.

13. The method of claim 8, further comprising:
parsing the query by splitting the query into tokens, relational operators, values, or logical operators; and
organizing the parsed query into a logical tree,
wherein the query is converted into the first format using the logical tree.

14. The method of claim 13, further comprising:
identifying a second interface on which to execute the query;
using the logical tree structure to convert the query into a second format suitable for use with the second interface;
executing the query in the second format on the second target system that uses the second interface such that the query is transmitted to the second target system in the second format and the second target system processes the query by retrieving or modifying requested data;
receiving the results of the executed query from the second target system; and
aggregating the results from the first target system and the second target system for display on the graphical user interface.

15. A computer program product comprising a non-transitory computer readable storage medium having instructions encoded thereon that, when executed by a computing system, cause the computing system to perform operations including:
receiving a query from a user device;
identifying a first interface of a plurality of interfaces on which to execute the query;
converting the query into a first format suitable for use with the first interface;
executing the query in the first format on a first target system that uses the first interface such that the query is transmitted to the first target system in the first format and the first target system processes the query by retrieving or modifying requested data;
receiving the results of the executed query from the first target system; and
causing a graphical user interface of an application running on the user device to display the received results.

16. The computer program product of claim 15, further comprising:
identifying a second interface on which to execute the query;
converting the query into at least a second format suitable for use with the at least second interface;
executing the query in the second format on the at least second target system that uses the at least second interface such that the query is transmitted to the at least second target system in the second format and the at least second target system processes the query by retrieving or modifying requested data;
receiving the results of the executed query from the at least second target system; and
aggregating the results from the first target system and the at least second target system for display on the graphical user interface.

17. The computer program product of claim 15, further comprising:
storing a previously executed query or its results to reduce a processing load on target systems and improve response times for frequently executed queries.

18. The computer program product of claim 15, further comprising:
allowing users to track, compare or revert changes to their queries over time.

19. The computer program product of claim 15, further comprising:
determining a level of access granted to the user; and
executing the query based on the level of access granted to the user to ensure that the query respects security and permission boundaries granted to the user.

20. The computer program product of claim 15, further comprising:
parsing the query by splitting the query into tokens, relational operators, values, or logical operators; and
organizing the parsed query into a logical tree,
wherein the query is converted into the first format using the logical tree.
